(19) United States
(12) Patent Application Publication
(10) Pub. No.: US 2024/0416790 A1
(43) Pub. Date: Dec. 19, 2024

(54) A METHOD FOR CHARGING A PLURALITY OF ELECTRIC BATTERY UNITS OF A VEHICLE

(71) Applicant: Scania CV AB, Södertälje (SE)

(72) Inventors: Anna ANDERSSON, Tullinge (SE); Tobias BRÄNNVALL, Södertälje (SE)

(73) Assignee: Scania CV AB, Södertälje (SE)

(21) Appl. No.: 18/700,618

(22) PCT Filed: Oct. 13, 2022
(86) PCT No.: PCT/SE2022/050927

§ 371 Date: Apr. 11, 2024

(30) Foreign Application Priority Data
Oct. 21, 2021 (SE) 2151278-5

(51) Int. Cl. B60L 53/66; B60L 53/62; B60L 58/12; H02J 7/00

(52) U.S. Cl. CPC B60L 53/66; B60L 53/62; B60L 58/12; H02J 7/0019; B60L 2240/34; B60L 2240/545; B60L 2240/80; B60L 2250/12; B60L 2250/14; H02J 2310/48

(57) ABSTRACT

A method for charging a plurality of electric battery units of a vehicle before a scheduled departure time, wherein the method comprises: waking up the vehicle to a wake-up mode; when the vehicle is in the wake-up mode, setting the vehicle in a charging mode; when the vehicle is in the charging mode, connecting one or more electric battery units of a subset of electric battery units of the plurality of electric battery units so as to charge the connected one or more electric battery units of the subset of electric battery units; and when the vehicle is in the charging mode, checking the status of the vehicle. A control arrangement for charging a plurality of electric battery units of a vehicle, wherein the control arrangement is configured to perform the method. A vehicle comprising such a control arrangement.

### TECHNICAL FIELD

Aspects of the present invention relate to a method for charging a plurality of electric battery units of a vehicle before a scheduled departure time.

### BACKGROUND

It may be advantageous and desirable that the electric battery units, such as the electric battery packs, especially the ones used for the propulsion of a vehicle, are sufficiently charged when it is time for the vehicle to depart, for example essentially fully charged.

### SUMMARY

The inventors of the present invention have found drawbacks in conventional solutions for charging the electric battery units, such as the electric battery packs, of a vehicle so as to have the electric battery units sufficiently charged when it is time for the vehicle to depart, for example essentially fully charged. For example, some conventional solutions have one or more monitoring schemes for monitoring the vehicle and/or the electric battery units before the departure which may contribute to an increased level of wear on the vehicle.

An object of the invention is to provide a solution which mitigates or solves the drawbacks and problems of conventional solutions.

The above and further objects are solved by the subject matter of the independent claims. Further advantageous embodiments of the invention can be found in the dependent claims.

According to a first aspect of the invention, the above mentioned and other objects are achieved with a method for charging a plurality of electric battery units of a vehicle before a scheduled departure time, wherein the method comprises:
waking up the vehicle to a wake-up mode;
when the vehicle is in the wake-up mode, setting the vehicle in a charging mode;
when the vehicle is in the charging mode, connecting one or more electric battery units of a subset of electric battery units of the plurality of electric battery units so as to charge the connected one or more electric battery units of the subset of electric battery units; and
when the vehicle is in the charging mode, checking the status of the vehicle.

An advantage of the method according to the first aspect is that the overall wear on the vehicle and/or on electric battery units is reduced, since one or more electric battery units of only a subset of electric battery units is/are connected to be charged for the performance of the status check when the vehicle is in the charging mode and/or in the wake-up mode. An advantage of the method according to the first aspect is that the overall lifetime, or durability, of the electric battery units is increased. An advantage of the method according to the first aspect is that the monitoring of the vehicle and/or of electric battery units of the vehicle is improved. For example the monitoring of the vehicle and/or of electric battery units provided by the method according to the first aspect results in less wear on the vehicle in relation to conventional monitoring schemes, for example less overall wear on the electric battery units in relation to conventional solutions, since one or more electric battery units of only a subset of electric battery units is/are connected to be charged for the performance of the status check. An advantage of the method according to the first aspect is that the charging of the electric battery units of the vehicle to a desired state of charge, SoC, is improved. For example, the desired state of charge, SoC, may be approximately 100%, or close to 100%. However, the desired state of charge, SoC, may be less than 100%, for example 70%, or 80%, or any other desired state of charge, SoC. The desired state of charge, SoC, may be set, or entered, by a user or driver.

For some embodiments, the step of waking up the vehicle to a wake-up mode may be described as a step of setting the vehicle in a wake-up mode. It is to be understood that a plurality of electric battery units comprises two or more electric battery units. For some embodiments, the plurality of electric battery units may comprise five or more electric battery units. For some embodiments, the plurality of electric battery units may comprise a plurality of electric battery packs. It is to be understood that “a subset of electric battery units” is a subset of the plurality of electric battery units.

According to an advantageous embodiment of the method according to the first aspect, the method further comprises checking the temperature of one or more entities of the vehicle. An advantage of this embodiment is that the monitoring of the vehicle and/or of electric battery units of the vehicle is further improved. An advantage of this embodiment is that the charging of the electric battery units of the vehicle to a desired state of charge, SoC, is further improved. The entity of the one or more entities may be an item of the vehicle, an electric battery unit, an interior space of the vehicle, a device of the vehicle, a system, or any other arrangement of the vehicle. For example, if the temperature of one entity is too low after checking the temperature, an action may be performed to increase the temperature of the entity or of the one or more entities, for example the temperature of an electric battery unit. Since one or more electric battery units of only a subset of electric battery units is/are connected to be charged for the performance of the temperature check, the overall wear on the vehicle and/or on electric battery units is reduced, and the monitoring of the vehicle and/or of electric battery units of the vehicle is thus improved.

According to a further advantageous embodiment of the method according to the first aspect, the method further comprises checking the temperature of an interior space of the vehicle. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to another advantageous embodiment of the method according to the first aspect, the method further comprises checking the status of the connected one or more electric battery units of the subset of electric battery units. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to yet another advantageous embodiment of the method according to the first aspect, the method further comprises checking the temperature of the connected one or more electric battery units of the subset of electric battery units. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to still another advantageous embodiment of the method according to the first aspect, the method further comprises checking the state of charge, SoC, of the connected one or more electric battery units of the subset of electric battery units. An advantage of this embodiment is that the monitoring of the vehicle and/or of electric battery units of the vehicle is further improved. An advantage of this embodiment is that the charging of the electric battery units of the vehicle to a desired state of charge, SoC, is further improved. For alternative embodiments, or in addition thereto, the method may comprise checking the depth of discharge, DoD, of the connected one or more electric battery units of the subset of electric battery units.

According to an advantageous embodiment of the method according to the first aspect, the method is performed when the vehicle is connected to a charging station. However, for alternative embodiments, the method may be performed when the vehicle is disconnected from a charging station, i.e. not connected to a charging station.

According to a further advantageous embodiment of the method according to the first aspect, the electric battery unit of the plurality of electric battery units comprises one or more contactors switchable between a non-conducting state and a conducting state,
wherein when the contactor is in the conducting state the contactor is configured to pass an electric current,
wherein when the contactor is in the non-conducting state the contactor is configured to interrupt an electric current, and
wherein the step of connecting the one or more electric battery units of the subset of electric battery units comprises controlling the one or more contactors of the one or more electric battery units of the subset of electric battery units to switch from the non-conducting state to the conducting state.

An advantage of this embodiment is that the overall wear on the contactors of the electric battery units is reduced, since the one or more contactors of one or more electric battery units of only a subset of electric battery units is/are switched to charge the one or more electric battery units of the subset of electric battery units to perform the status check when the vehicle is in the charging mode and/or in the wake-up mode. Thus, the overall lifetime, or durability, of the contactors electric battery units is increased. For example, for electric battery packs, the contactor may be integrated in the electric battery packs, so if a contactor fails because of wear often the entire electric battery pack has to be replaced. An advantage of this embodiment is that the monitoring of the vehicle and/or of electric battery units of the vehicle is further improved. An advantage of this embodiment is that the charging of the electric battery units of the vehicle to a desired state of charge, SoC, is further improved. For some embodiments, the non-conducting state may correspond to an open position while the conducting state may correspond to a closes position.

According to another advantageous embodiment of the method according to the first aspect, the method comprises setting the vehicle in the charging mode for less than five minutes. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to yet another advantageous embodiment of the method according to the first aspect, the method is performed recurringly during a time period before the scheduled departure time. An advantage of this embodiment is that the monitoring of the vehicle and/or of electric battery units of the vehicle is further improved. An advantage of this embodiment is that the charging of the electric battery units of the vehicle to a desired state of charge, SoC, is further improved. 30

According to still another advantageous embodiment of the method according to the first aspect, when the method is performed recurringly during said time period, the method is performed such that different subsets of electric battery units are used during said time period. An advantage of this embodiment is that the wear on the electric battery units may be substantially evenly distributed among the electric battery units, thereby avoiding that certain electric battery units are subjected to excessive wear, or more wear than others. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to an advantageous embodiment of the method according to the first aspect, when the method is performed recurringly during said time period, the method is performed such that during said time period one of the electric battery units of the subset of electric battery units being previously connected is subsequently left (or kept) unconnected (or disconnected) and/or such that during said time period one of the electric battery units of the subset of electric battery units being previously left unconnected is subsequently connected. An advantage of this embodiment is that the wear on the electric battery units may be substantially evenly distributed among the electric battery units, thereby avoiding that certain electric battery units are subjected to more wear than others. An advantage of this embodiment is that the monitoring of the vehicle and/or of electric battery units of the vehicle is further improved. An advantage of this embodiment is that the charging of the electric battery units of the vehicle to a desired state of charge, SoC, is further improved.

According to a second aspect of the invention, the above mentioned and other objects are achieved with a computer program comprising instructions which, when the program is executed by a computer, cause the computer to carry out the method according to any one of the embodiments disclosed above or below. Advantages of the computer program according to the second aspect correspond to advantages of the method according to the first aspect and its embodiments mentioned above or below.

According to a third aspect of the invention, the above mentioned and other objects are achieved with a computer-readable medium comprising instructions which, when the instructions are executed by a computer, cause the computer to carry out the method according to any one of the embodiments disclosed above or below. Advantages of the computer-readable medium according to the third aspect correspond to advantages of the method according to the first aspect and its embodiments mentioned above or below.

According to an aspect of the present invention, the above-mentioned computer program and/or the computer-readable medium are/is configured to implement the method and its embodiments described herein.

According to a fourth aspect of the invention, the above mentioned and other objects are achieved with a control arrangement for charging a plurality of electric battery units of a vehicle, wherein the control arrangement is configured to:
wake up the vehicle to a wake-up mode;
when the vehicle is in the wake-up mode, set the vehicle in a charging mode;
when the vehicle is in the charging mode, connect one or more electric battery units of a subset of electric battery units of the plurality of electric battery units so as to charge the connected one or more electric battery units of the subset of electric battery units; and
when the vehicle is in the charging mode, check the status of the vehicle.

Advantages of the control arrangement according to the fourth aspect correspond to advantages of the method according to the first aspect and its embodiments mentioned above or below.

It is to be appreciated that all the embodiments described for the method aspects of the invention are applicable also to the control arrangement aspects of the invention. Thus, all embodiments described for the method aspects of the invention may be performed by the control arrangement, which may include one or more control units, or one or more control devices. The embodiments of the control arrangement have advantages corresponding to advantages mentioned above for the method and its embodiments.

According to a fifth aspect of the invention, the above mentioned and other objects are achieved with a vehicle comprising a control arrangement according to any one of the embodiments disclosed above or below.

Advantages of the vehicle according to the fifth aspect correspond advantages of the method according to the first aspect and its embodiments mentioned above or below.

The vehicle may be a wheeled vehicle, i.e. a vehicle having wheels. The vehicle may for example be a bus, a tractor vehicle, a heavy vehicle, a truck, or a car. The tractor vehicle, and/or the truck, may, or may be configured to, haul, or pull, a trailer. However, other types of vehicles are possible. The vehicle may be referred to as a motor vehicle. The vehicle may be an electric vehicle, EV, for example a hybrid vehicle or a hybrid electric vehicle, HEV, or a battery electric vehicle, BEV. Thus, a hybrid electric vehicle, HEV, and a battery electric vehicle, BEV, are versions, or examples, of an electric vehicle, EV. The EV may comprise one or more electric machines. The vehicle may comprise a combustion engine.

The vehicle may comprise a powertrain. The powertrain may be configured in accordance with any one of the embodiments disclosed above or below. The vehicle may comprise one or more of the group of: an electric battery unit; an electric battery; and an electric battery pack. The powertrain of the vehicle may comprise one or more of the group of: a combustion engine; an electric machine; an electric engine; an inverter; a converter; one or more electric battery cells; an electric battery unit, for example an electric battery, or an electric battery pack.

The above-mentioned features and embodiments of the method, the computer program, the computer-readable medium, the control arrangement and the vehicle, respectively, may be combined in various possible ways providing further advantageous embodiments.

Further advantageous embodiments of the method, the computer program, the computer-readable medium, the control arrangement and the vehicle according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic side view of an embodiment of the vehicle according to the fifth aspect of the invention to which embodiments of the method according to the first aspect of the invention may be applied;

FIG. 2 is a schematic diagram illustrating an example of an electric battery unit;

FIG. 3 is a schematic diagram illustrating another example of an electric battery unit, more specifically an example of an electric battery pack;

FIG. 4 is a schematic flow chart illustrating aspects of embodiments of the method according to the first aspect of the invention;

FIG. 5 is another schematic flow chart illustrating further aspects of embodiments of the method according to the first aspect of the invention; and

FIG. 6 is a schematic diagram illustrating an embodiment of the control arrangement according to the fourth aspect of the invention, in which a method according to any one of the herein described embodiments may be implemented.

### DETAILED DESCRIPTION

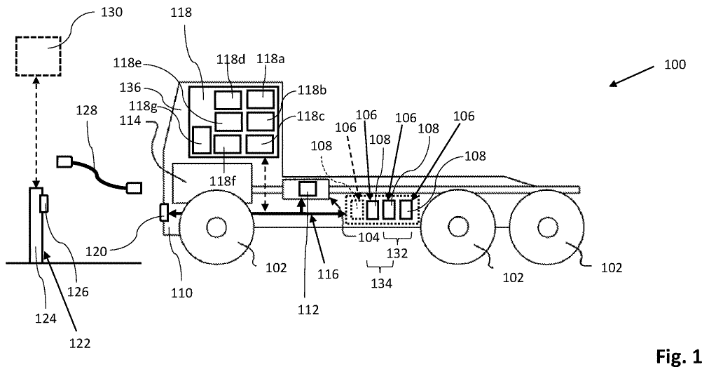

With reference to FIG. 1, an embodiment of the vehicle 100 according to the fifth aspect of the invention is schematically illustrated. The vehicle 100 of FIG. 1 also represents an example of a vehicle 100 to which embodiments of the method according the first aspect of the invention may be applied. The vehicle 100 is illustrated as a tractor vehicle. However, for other embodiments, the vehicle 100 may, for example, be a bus, a truck, a heavy truck, a dump truck, an excavator, or a car. Other types of vehicles are also possible, for example trains, vessels, watercrafts, or aircrafts. The vehicle 100 may be an electric vehicle, EV, for example a hybrid vehicle or a hybrid electric vehicle, HEV, or a battery electric vehicle, BEV.

With reference to FIG. 1, the vehicle 100 may be a wheeled vehicle, i.e. a vehicle 100 having wheels 102. Only the wheels 102 on the left-hand side of the vehicle 100 are visible in FIG. 1. It is to be understood that the vehicle 100 may have fewer or more wheels 102 than what is shown in FIG. 1. The vehicle 100 may comprise a powertrain 104, for example configured for one of an EV, HEV and BEV. The vehicle 100 may be configured to hold or carry, or may include, a plurality of electric battery units 106, for example a plurality of electric battery packs 108. However, the plurality of electric battery units 106 may comprise any other plurality of electric battery units holding electric battery cells. The plurality of electric battery units 106 may be configured for the propulsion of the vehicle 100. The plurality of electric battery units 106 may be mounted to a chassis 110 of the vehicle 100. In FIG. 1, only four electric battery units 106 are illustrated but it is to be understood that the vehicle 100 may include any number of electric battery units 106, for example two, or more than two, such as more than four, for example more than eight, such as ten electric battery units 106.

With reference to FIG. 1, the vehicle 100 may comprise one or more electric machines 112 for the propulsion of the vehicle 100. For some embodiments, the vehicle 100 may comprise a combustion engine 114, which for example may be the case for a HEV. It is to be understood that the vehicle 100 may include further units, components, such as electrical and/or mechanical components, and other devices required for a vehicle 100, such as for an EV, HEV or BEV. It may be defined that the powertrain 104 and/or the one or more electric machines 112 is/are configured to propel, or drive, the vehicle 100. For some embodiments, it may be defined that the powertrain 104 includes the plurality of electric battery units 106.

The vehicle 100 may include a vehicle electrical system 116. For some embodiments, the vehicle electrical system 116 may be a vehicle high voltage system. For some embodiments, the vehicle electrical system 116 includes the plurality of electric battery units 106. It may be defined that the vehicle electrical system 116 is configured for direct current and/or is configured to transfer direct current. It may be defined that the vehicle electrical system 116 is configured for a high voltage, such as a voltage above 60 V, for example above 400 V, or above 450 V, such as above 650 V. For example, the vehicle electrical system 116 may be configured for a voltage up to 1500 V and/or for a voltage above 1500 V. The electric power, or the electric current, for example the direct current, of the vehicle electrical system 116 may be transferred at a high voltage, for example at one or more of the voltages levels mentioned above. Thus, the vehicle electrical system 116 may be configured to transfer the electric power, or the electric current, at a high voltage, for example at one or more of the voltages levels mentioned above. It may be defined that the plurality of electric battery units 106 is configured for a high voltage, for example for one or more of the voltages levels mentioned above.

With reference to FIG. 1, the vehicle electrical system 116 may be electrically connected to the plurality of electric battery units 106. The vehicle electrical system 116 may be configured to electrically connect the plurality of electric battery units 106 to the powertrain 104 of the vehicle 100. The vehicle electrical system 116 may be configured to electrically connect the plurality of electric battery units 106 to the one or more electric machines 112 of the vehicle 100. It may be defined that the vehicle electrical system 116 is configured to transfer the electric power, or the electric current, between the one or more electric machines 112 (and/or the powertrain 104) and the plurality of electric battery units 106.

With reference to FIG. 1, the vehicle 100 includes a control arrangement 118 according to any one of the embodiments disclosed below or below and/or according to the fourth aspect of the invention. The control arrangement 118 is further disclosed hereinbelow.

The vehicle 100 may include a connector 120 for connecting, such as electrically connecting, the vehicle 100 to a charging station 122. The charging station 122 may comprise a charging post 124 provided with, or comprising, a charging station connector 126. However, the charging post 124 may be excluded, and the charging station connector 126 may be arranged in other manners, for example, the charging station connector 126 may be mounted to a wall, or any other structure. The connector 120 of the vehicle 100 may be connected, or connectable, to one or more of the group of: the vehicle electrical system 116; the plurality of electric battery units 106; and the control arrangement 118. Further, the connector 120 of the vehicle 100 may be connected, or connectable, to other devices or systems of the vehicle 100. For charging the plurality of electric battery units 106 of the vehicle 100, the vehicle 100 may be connected to the charging station 122, for example by way of the connector 120, the charging station connector 126 and an electrical cable 128. For some embodiments, the electrical cable 128 may be fixedly connected to the charging station connector 126 and/or to the charging post 124. For some embodiments, the electrical cable 128 and the charging station connector 126 may form a single unit. For some embodiments, the electrical cable 128 may be configured to be disconnected from the charging station connector 126 and/or from the connector 120, for example when not in use. A charging system 130 may be provided, which comprises, or is configured to communicate with, for example via the internet or other means, the charging station 122. In general, the plurality of electric battery units 106 is rechargeable.

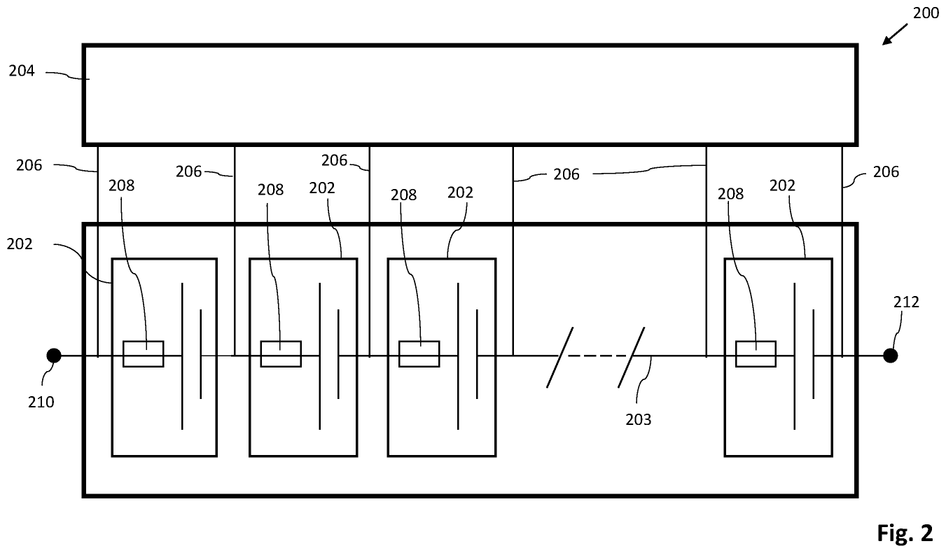

An electric battery pack 108 may comprise, or be built up by, a plurality of electric battery modules 200. However, this not always the case. With reference to FIG. 2, an example of an electric battery module 200 is schematically illustrated in the form of a schematic circuit diagram, wherein the electric battery module 200 includes a plurality of electric battery cells 202, i.e. two or more electric battery cells 202.

With reference to FIG. 2, each electric battery cell 202 can be seen as a container chemically storing energy and may be a rechargeable electric battery cell 202. The electric battery cells 202 may be electrically connected in series and/or in parallel, into the electric battery module 200 in order to attain the desired voltage and energy capacity. In the shown example, the electric battery cells 202 are electrically connected in series with one another. In the shown example, the electric battery cells 202 are part of a main power line 203. However, in other examples, the main power line 203 may be excluded, and the electric battery cells 202 may be electrically interconnected in other ways.

With reference to FIG. 2, the electric battery module 200 may include a cell controller 204 which may be electrically connected in parallel with each electric battery cell 202 by way of a plurality of electrical lines 206, for example electrical wires. The cell controller 204 may be referred to as a cell module controller, CMC. The electric battery cell 202 may include a cell fuse 208, for example, for short-circuit and/over voltage protection. However, for some embodiments, the cell fuse 208 may be excluded.

With reference to FIG. 2, the electric battery module 200 may have two terminals 210, 212 for connecting the electric battery module 200 to an electrical system, for example to one or more electrical loads, for example via a vehicle electrical system 116 (see FIG. 1) and/or via electrical conductors. The two terminals 210, 212 may be referred to as electrical contacts. One 210, 212 of the two terminals 210, 212 may be a negative terminal having a negative pole while the other one 210, 212 of the two terminals 210, 212 may be a positive terminal having a positive pole. The electric battery module 200 may be configured for the propulsion of a vehicle 100.

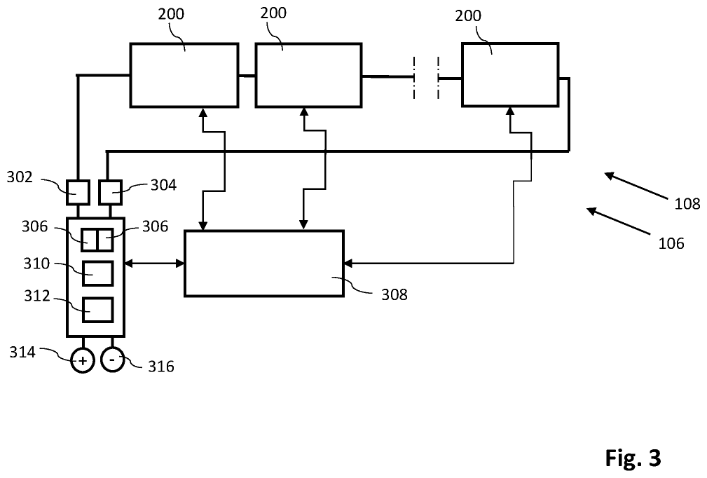

As mentioned above, one or more electric battery modules 200 may be included in, or form, an electric battery pack 108. An example of an electric battery pack 108 is schematically illustrated in FIG. 3, for example suitable for a vehicle 100 (see FIG. 1). It may be defined that the electric battery pack 108 is configured for the propulsion of a vehicle 100. The electric battery pack 108 may comprise two or more electric battery modules 200, which may be electrically connected in series and have two common outputs 302, 304 (positive and negative) for electric power, or current, transfer. The electric battery pack 108 may have two terminals 314, 316 (DC positive and DC negative) for electric power, or current, transfer, to be connected to one or more electrical loads, for example via a vehicle electrical system 116 (see FIG. 1) and/or via electrical conductors. The above-mentioned two common outputs 302, 304 may be connected to the two terminals 314, 316 of the electric battery pack 108.

With reference to FIG. 3, the electric battery pack 108 may comprise one or more contactors 306 switchable between an open position, or a non-conducting state, and a closed position, or a conducting state. The electric battery pack 108 may include a battery management system 308, BMS. The battery management system 308 may be described as a control system for controlling the electric battery pack 108. The one or more contactors 306 of the electric battery pack 108 may be controlled by the battery management system 308. The battery management system 308 may be connected to and communicate with the above-mentioned cell module controller, CMC, 204 of the electric battery module 200 illustrated in FIG. 2. For some embodiments, the contactor 306 may be described as a mechanical contactor or mechanical switch. For some embodiments, the contactor 306 may be defined as an electrically operable contactor.

With reference to FIG. 3, the electric battery pack 108 may include a pre-charge switch 310, or pre-charge contactor, switchable between an open position, or a non-conducting state, and a closed position, or a conducting state. In general, when the battery management system 308 is activated or active, a pre-charging of an electrical system (such as a vehicle electrical system), to which the electric battery pack 108 is connected, may be performed before all the contactors 306 are closed, for example with the aid of the pre-charge switch 310. Pre-charging of a high voltage direct current system is known to the person skilled in the art and is thus not discussed in further detail.

With reference to FIG. 3, the electric battery pack 108 may comprises an electric battery pack fuse 312, which, for example, may be a melt fuse, or a pyrotechnic fuse (or pyro fuse), for protection. It is to be understood that the electric battery pack 108 may include additional electrical components or equipment, such as sensors, but these are left out for illustrative purposes. Although the electric battery pack 108 disclosed is built up by a plurality of electric battery modules 200, it is to be understood that an electric battery pack 108 does not necessarily have to be formed by a plurality of electric battery modules 200. Instead, the electric battery pack 108 may include a plurality of electric battery cells 202 without the presence of any electric battery module/modules 200.

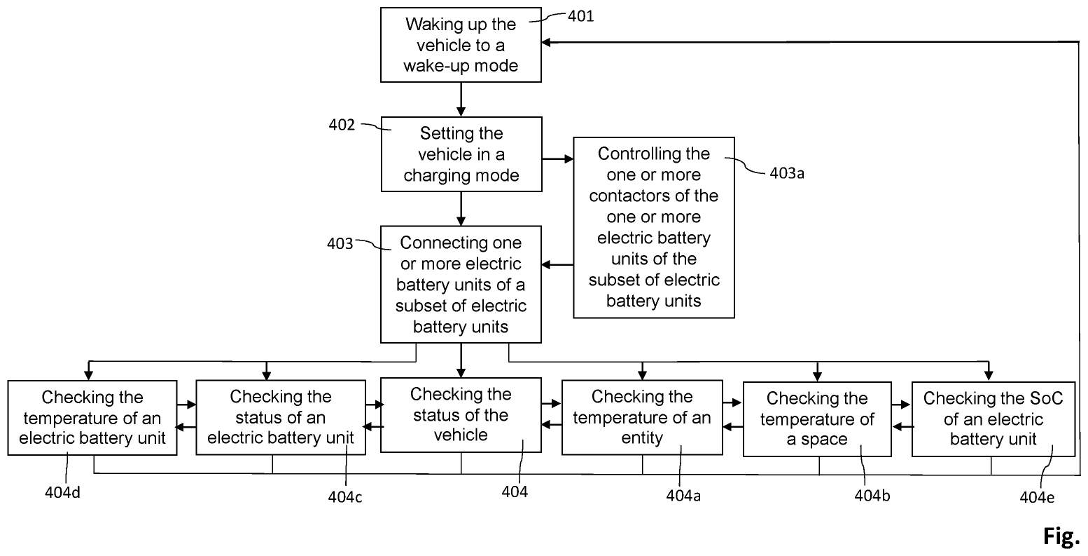

With reference to FIG. 4, aspects of embodiments of the method for charging a plurality of electric battery units 106 of a vehicle 100 before a scheduled departure time according to the first aspect of the invention are schematically illustrated. The plurality of electric battery units 106 may be a plurality of electric battery packs 108, for example as disclosed above.

With reference to FIG. 4, the method includes the steps of:
waking up 401 the vehicle 100 to a wake-up mode, or setting 401 the vehicle in a wake-up mode, for example from a sleep mode;
when the vehicle 100 is in the wake-up mode, setting 402 the vehicle 100 in a charging mode;
when the vehicle 100 is in the charging mode, connecting 403 one or more electric battery units 106 of a subset 132 (see FIG. 1) of electric battery units 106 of the plurality of electric battery units 106 so as to charge the connected one or more electric battery units 106 of the subset 132 of electric battery units 106; and
when the vehicle 100 is in the charging mode, checking 404 the status of the vehicle.

It is to be understood that “a subset 132 of electric battery units 106” of the plurality of electric battery units 106 does not include all electric battery units 106 of the plurality of electric battery units 106 but includes fewer electric battery units 106 than all electric battery units 106 of the plurality of electric battery units 106. For some embodiments, the subset 132 of electric battery units 106 may be referred to as a group of electric battery units 106 of the plurality of electric battery units 106. It is to be understood that “a subset 132 of electric battery units 106” is a subset of the plurality of electric battery units 106.

The scheduled departure time mentioned above may be entered by a user, or driver, for example when the user connects the vehicle 100 to a charging station 122. The vehicle 100 may have, or be associated with, a functionality which includes the goal of having a vehicle 100 ready to depart at the scheduled departure time, with fully, or sufficiently, charged electric battery units 106 and optimal temperatures in the vehicle 100, for example a sufficient and suitable temperature in the cabin, which is an example of an interior space 136, of the vehicle 100, and optimal operating temperatures in the electric battery units 106. Another goal of said functionality is to be able to utilize the full capacity of the electric battery units 106 to increase the range of driving before a new charging session is required. When the user has entered the scheduled departure time, by way of said functionality one or more of the charging system 130, charging station 122, vehicle 100 and control arrangement 118 may determine when the charging of the electric battery units 106 to the desired state of charge, SoC, is to start in order to reach said goals. To reach said goals, in general, the vehicle 100 is woken up to a wake-up mode multiple times before the scheduled departure time, for example when the vehicle 100 is connected to the charging station 122 in order to check the status of the vehicle 100. For some embodiments, for example when the vehicle 100 is connected to the charging station 122, the vehicle 100 may be woken up to the wake-up mode once every hour before the scheduled departure time for checking the status of the vehicle 100, for example checking the state of charge, SoC, of the electric battery units 106 and relevant temperatures. For example, the desired state of charge, SoC, may be approximately 100%, or close to 100%. However, the desired state of charge, SoC, may be less than 100%, for example 70%, or 80%, or any other desired state of charge, SoC. The desired state of charge, SoC, may be set, or entered, by a user, or a driver.

With reference to FIG. 4, in general, the wake-up mode in step 401 may include, or involve, waking up, or activating, some systems and/or units of the vehicle 100, such as one or more control units, for example one or more electronic control units, ECUs, one or more battery management systems 308 and one or more cell module controllers 204. However, in general, in the wake-up mode in step 401 not all systems and units of the vehicle 100 are necessarily woken up (or activated), but sufficiently many in order to be able to perform relevant status checks of the vehicle 100 in step 404. In general, or for some embodiments, the charging mode in step 402 may described as a limited, or minor, charging mode. In the charging mode in step 402, enough charging for making the performance of the status check in step 404 possible may be performed. In general, in the charging mode in step 402, the electric battery units 106 are not charged to or toward a desired state of charge, SoC. In the charging mode in step 402, the charging, or charging session, may last less than ten minutes, for example less than five minutes.

With reference to FIG. 4, embodiments of the method may include one or more of the steps of:
checking 404a the temperature of one or more entities of the vehicle 100. The entity may be an item of the vehicle 100, an electric battery unit 106, an interior space 136 of the vehicle 100, a device of the vehicle 100, a system or any other arrangement of the vehicle 100;
checking 404b the temperature of an interior space 136 of the vehicle 100;
checking 404c the status of the connected one or more electric battery units 106 of the subset 132 of electric battery units 106;
checking 404d the temperature of the connected one or more electric battery units 106 of the subset 132 of electric battery units 106; and
checking 404e the state of charge, SoC, of the connected one or more electric battery units 106 of the subset 132 of electric battery units 106.

For some embodiments, the method may include the step of checking the depth of discharge, DoD, for example the energy left to charge, of the connected one or more electric battery units 106 of the subset 132 of electric battery units 106. For some embodiments, the method may comprise checking one of the SoC and DoD of the connected one or more electric battery units 106 of the subset 132 of electric battery units 106.

With reference to FIG. 4, for some embodiments, the method is performed when the vehicle 100 is connected to a charging station 122.

However, for alternative embodiments, the method may be performed when the vehicle 100 is disconnected from a charging station 122, i.e. not connected to a charging station 122. For example, when the vehicle 100 is parked and already has a desired state of charge, SoC, a scheduled departure time, for example 08.00 AM, may be entered by the user without having the vehicle 100 connected to a charging station 122. A functionality of the vehicle 100 may include the goal of having a vehicle 100 ready to depart at the scheduled departure time with an optimal temperature in the vehicle 100, for example a sufficient and suitable temperature in the cabin, such as 20° C. Thus, for this case, embodiments of the method may include the step of checking 404b the temperature of an interior space 136, for example the cabin, of the vehicle 100 when the vehicle 100 is in the above- or below-mentioned charging mode and when the vehicle 100 is disconnected from a charging station 122.

With reference to FIG. 3, the electric battery unit 106 of the plurality of electric battery units 106 may include one or more contactors 306 switchable between a non-conducting state and a conducting state, or switchable between an open position and a closed position. When the contactor 306 is in the conducting state the contactor 306 is configured to pass an electric current while when the contactor 306 is in the non-conducting state the contactor 306 is configured to interrupt an electric current. With reference to FIG. 4, for some embodiments, the step of connecting 403 the one or more electric battery units 106 of the subset 132 of electric battery units 106 includes controlling 403a the one or more contactors 306 of the one or more electric battery units 106 of the subset 132 of electric battery units 106 to switch from the non-conducting state to the conducting state.

For some embodiments, when the vehicle 100 is in the charging mode, the method may include the step of controlling one or more electric battery units 106 of a subset 132 of electric battery units 106 of the plurality of electric battery units 106 to be connected so as to charge the connected one or more electric battery units 106 of the subset 132 of electric battery units 106. For some embodiments, when the vehicle 100 is in the charging mode, the method may include the step of controlling the one or more contactors 306 of one or more electric battery units 106 of a subset 132 of electric battery units 106 of the plurality of electric battery units 106 such that the one or more electric battery units 106 of the subset 132 of electric battery units 106 is/are connected so as to charge the connected one or more electric battery units 106 of the subset 132 of electric battery units 106.

With reference to FIG. 4, for some embodiments, the method comprises setting 402 the vehicle 100 in the charging mode for less than five minutes. For some embodiments, the method comprises setting 402 the vehicle 100 in the charging mode for less than three minutes, for example for about one minute, or about two minutes.

With reference to FIG. 4, for some embodiments, the method is performed recurringly during a time period before the scheduled departure time. When the method is performed recurringly, i.e. performed multiple times, during said time period, the method may be performed such that different subsets 132, 134 (see FIG. 1) of electric battery units 106 are used during said time period. For some embodiments, when the method is performed recurringly during said time period, the method is performed such that during said time period one 106 of the electric battery units 106 of the subset 132 of electric battery units 106 being previously connected is subsequently left, or kept, unconnected (or disconnected) and/or such that during said time period one 106 of the electric battery units 106 of the subset 132 of electric battery units 106 being previously left unconnected is subsequently connected.

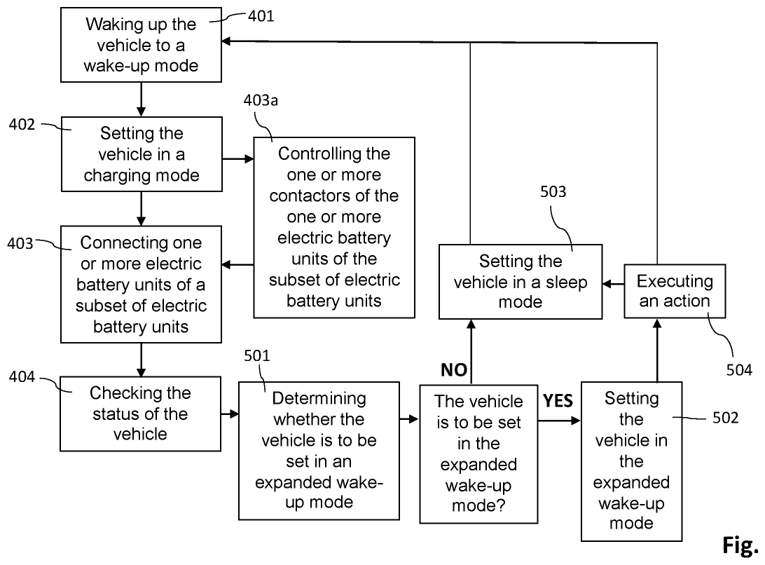

With reference to FIG. 5, for some embodiments, in view of the result, or outcome, of the step of checking 404 the status of the vehicle 100 and in response thereto, for example if an action is required, the method may include the step of determining 501 whether the vehicle 100 is to be set in an expanded wake-up mode, in which mode, for example, more systems and/or units, such as more ECUs, of the vehicle 100 are set in a wake-up mode (or activated) compared to the amount of systems and units woken up, or activated, in the wake-up mode in step 401. For some embodiments, in the expanded wake-up mode, some systems and/or units may be woken up to a higher degree compared to the wake-up mode in step 401. For example, said determination step 501 may be performed by one or more of the group of: the charging system 130; the charging station 122; the vehicle 100; and the control arrangement 118. Subsequent to the determination step 501, the method may include the step of setting 502 the vehicle 100 in the expanded wake-up mode or setting 503 the vehicle 100 in a sleep mode. When the vehicle 100 is in the expanded wake-up mode, the method may include the step of executing 504 an action, or performing an action. For example, the step of executing 504 an action may include charging one or more electric battery units 106 to increase the state of charge, SoC, of the electric battery unit 106, for example to or toward a desired state of charge, SoC, and/or increasing the temperature of one or more entities of the vehicle 100. For example, the temperature of an interior space 136, such as the cab/cabin/compartment, of the vehicle 100 may be increased. For example, the temperature of one or more electric battery units 106 may be increased, for example to an optimal operating temperature. Subsequent to step 504, the step of setting 503 the vehicle 100 in a sleep mode may be performed.

Unless disclosed otherwise, it should be noted that the method steps illustrated in FIGS. 4 and 5 and described herein do not necessarily have to be executed in the order illustrated in FIGS. 4 and 5. The steps may essentially be executed in any suitable order. Further, one or more steps may be added without departing from the scope of the appended claims. One or more steps may be excluded without departing from the scope of the appended claims.

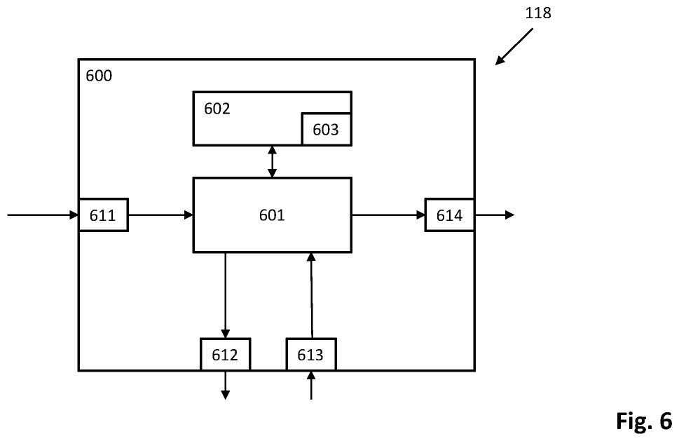

With reference to FIGS. 1 and 6, aspects of embodiments of the control arrangement 118 for charging a plurality of electric battery units 106 of a vehicle 100 according to the fourth aspect, are schematically illustrated. Embodiments of the control arrangement 118 are configured to:
wake up 401 the vehicle 100 to a wake-up mode, or set 401 the vehicle in a wake-up mode, for example from a sleep mode;
when the vehicle 100 is in the wake-up mode, set 402 the vehicle 100 in a charging mode;
when the vehicle 100 is in the charging mode, connect 403 one or more electric battery units 106 of a subset 132 (see FIG. 1) of electric battery units 106 of the plurality of electric battery units 106 so as to charge the connected one or more electric battery units 106 of the subset 132 of electric battery units 106; and
when the vehicle 100 is in the charging mode, check 404 the status of the vehicle.

With reference to FIG. 1, the illustrated embodiment of the control arrangement 118 includes a wake-up unit 118a for waking up the vehicle 100 to a wake-up mode or setting the vehicle in a wake-up mode in order to perform step 401 in FIGS. 4 and 5. The illustrated embodiment of the control arrangement 118 includes a charging mode setting unit 118b for setting the vehicle 100 in a charging mode when the vehicle 100 is in the wake-up mode in order to perform step 402 in FIGS. 4 and 5. The illustrated embodiment of the control arrangement 118 includes a connection unit 118c for connecting one or more electric battery units 106 of a subset 132 (see FIG. 1) of electric battery units 106 of the plurality of electric battery units 106 so as to charge the connected one or more electric battery units 106 of the subset 132 of electric battery units 106 when the vehicle 100 is in the charging mode in order to perform step 403 in FIGS. 4 and 5. The illustrated embodiment of the control arrangement 118 includes a status checking unit 118d for checking 404 the status of the vehicle when the vehicle 100 is in the charging mode in order to perform step 404, and/or one or more of the steps 404a-e, in FIGS. 4 and 5.

With reference to FIG. 1, some embodiments of the control arrangement 118 may comprise a determination unit 118e for determining whether the vehicle 100 is to be set in an expanded wake-up mode in order to perform step 501 in FIG. 5. Some embodiments of the control arrangement 118 may include a mode setting unit 118f for setting the vehicle 100 in the expanded wake-up mode or setting the vehicle 100 in a sleep mode in order to perform steps 502 and 503 in FIG. 5. Some embodiments of the control arrangement 118 may include an action unit 504 for executing 504 an action in order to perform step 504 in FIG. 5.

With reference to FIG. 1, some embodiments of the control arrangement 118 may comprise a contactor control unit 118g for controlling and switching the one or more contactors of the one or more electric battery units 106 of the subset 132 (see FIG. 1) of electric battery units 106 in order to perform step 403a in FIGS. 4 and 5.

With reference to FIG. 1, for some embodiments, the control arrangement 118 is configured to directly or indirectly communicate, for example via signal lines (or cables or wires) or wirelessly, with one or more of the group of: a sensor device for detecting, or sensing, the temperature of one or more entities of the vehicle 100; a device for determining the state of charge, SoC, of one or more electric battery units 106, for example based on cell voltage, or on an electric current to, or from, an electric battery unit 106; a device for determining or detecting a cell voltage; a device for determining or detecting an electric current, for example an electric current to, or from, an electric battery unit 106; a sensor device for detecting the state of charge, SoC, of one or more electric battery units 106; a system; a control unit, for example an electronic control unit, ECU; the battery management system 308; and the cell module controller 204. Thus, for some embodiments, there may be one or more signal connections between the control arrangement 118 and one or more of the group of: a sensor device for detecting the temperature of one or more entities of the vehicle 100; a device for determining the state of charge, SoC, of one or more electric battery units 106, for example based on cell voltage, or on an electric current to, or from, an electric battery unit 106; a device for determining or detecting a cell voltage; a device for determining or detecting an electric current, for example an electric current to, or from, an electric battery unit 106; a sensor device for detecting the state of charge, SoC, of one or more electric battery units 106; a system; a control unit, for example an electronic control unit, ECU; the battery management system 308; and the cell module controller 204.

FIG. 6 shows in schematic representation an embodiment of the control arrangement 118 according to the fourth aspect of the invention, which may include a control unit 600, which may correspond to or may include one or more of the above-mentioned units 118a-g of the control arrangement 118. The control unit 600 may comprise a computing unit 601, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 601 is connected to a memory unit 602 arranged in the control unit 600. The memory unit 602 provides the computing unit 601 with, for example, the stored program code and/or the stored data which the computing unit 601 requires to be able to perform computations. The computing unit 601 is also arranged to store partial or final results of computations in the memory unit 602.

With reference to FIG. 6, in addition, the control unit 600 may be provided with devices 611, 612, 613, 614 for receiving and transmitting input and output signals. These input and output signals may contain waveforms, impulses, or other attributes which, by means of the devices 611, 613 for the reception of input signals, can be detected as information and can be converted into signals which can be processed by the computing unit 601. These signals are then made available to the computing unit 601.

The devices 612, 614 for the transmission of output signals are arranged to convert signals received from the computing unit 601 in order to create output signals by, for example, modulating the signals, which can be transmitted to other parts of and/or systems, for example in a vehicle 100 (see FIG. 1).

Each of the connections to the devices for receiving and transmitting input and output signals can be constituted by one or more of a cable; a data bus, such as a CAN bus (Controller Area Network bus), a MOST bus (Media Orientated Systems Transport bus), or some other bus configuration; or by a wireless connection.

Control systems in modern vehicles in general comprise communication bus systems consisting of one or more communication buses for linking a plurality of electronic control units (ECU's), or controllers, and various components located on the vehicle. Such a control system can comprise a large number of control units and/or control arrangements and the responsibility for a specific function can be divided amongst more than one control unit. Vehicles of the shown type thus often comprise significantly more control units or control arrangements than are shown in FIG. 1, which is well known to the person skilled in the art within this technical field. Alternatively, or in addition thereto, embodiments of the present invention may be implemented wholly or partially in one or more other control units already present in a vehicle 100.

Here and in this document, units are often described as being provided for performing steps of the method according to embodiments of the invention. This also includes that the units are designed to and/or configured to perform these method steps.

With reference to FIGS. 1, the units 118a-g of the control arrangement 118 are in FIG. 1 illustrated as separate units. These units 118a-g may, however, be logically separated but physically implemented in the same unit, or can be both logically and physically arranged together. These units 118a-g may for example correspond to groups of instructions, which can be in the form of programming code, that are input into, and are utilized by a processor/computing unit 601 (see FIG. 6) when the units are active and/or are utilized for performing its method step.

With reference to FIGS. 1 and 6, the control arrangement 118, which may include one or more control units 600, e.g. a device or a control device, according to embodiments of the present invention may be arranged to perform all of the method steps mentioned above, in the claims, and in connection with the herein described embodiments. The control arrangement 118 is associated with the above-described advantages for each respective embodiment.

With reference to FIG. 6, according to the second aspect of the invention, a computer program 603 is provided, comprising instructions which, when the program is executed by a computer, cause the computer to carry out the method according to one or more of the embodiments disclosed above.

According to the third aspect of the invention, a computer-readable medium is provided, comprising instructions which, when the instructions are executed by a computer, cause the computer to carry out the method according to one or more of the embodiments disclosed above.

The person skilled in the art will appreciate that the herein described embodiments of the method according to the first aspect may be implemented in a computer program 603 (see FIG. 6), which, when it is executed in a computer, instructs the computer to execute the method. The computer program is usually constituted by a computer program product 603 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

One or more functionalities according to embodiments of the invention may be added to ISO 15118, to the VDV 216 addition of ISO 15118, an/or to value-added services, VAS, which is a part of, or included in, the ISO 15118 standard and the VDV 261 addition. The VDV 261 addition may be described as a support or a specification.

The present invention is not limited to the above-described embodiments. Instead, the present invention relates to, and encompasses all different embodiments being included within the scope of the independent claims.

1. A method for charging a plurality of electric battery units of a vehicle before a scheduled departure time, wherein the method comprises:
waking up the vehicle to a wake-up mode;
when the vehicle is in the wake-up mode, setting the vehicle in a charging mode;
when the vehicle is in the charging mode, connecting one or more electric battery units of a subset of electric battery units of the plurality of electric battery units so as to charge the connected one or more electric battery units of the subset of electric battery units; and
when the vehicle is in the charging mode, checking the status of the vehicle.

2. The method according to claim 1, wherein the method further comprises checking the temperature of one or more entities of the vehicle.

3. The method according to claim 1, wherein the method further comprises checking the temperature of an interior space of the vehicle.

4. The method according to claim 1, wherein the method further comprises checking the status of the connected one or more electric battery units of the subset of electric battery units.

5. The method according to claim 1, wherein the method further comprises checking the temperature of the connected one or more electric battery units of the subset of electric battery units.

6. The method according to claim 1, wherein the method further comprises checking the state of charge, SoC, of the connected one or more electric battery units of the subset of electric battery units.

7. The method according to claim 1, wherein the method is performed when the vehicle is connected to a charging station.

8. The method according to claim 1, wherein the electric battery unit of the plurality of electric battery units comprises one or more contactors switchable between a non-conducting state and a conducting state,
wherein when the contactor is in the conducting state the contactor is configured to pass an electric current,
wherein when the contactor is in the non-conducting state the contactor is configured to interrupt an electric current, and
wherein the step of connecting the one or more electric battery units of the subset of electric battery units comprises controlling the one or more contactors of the one or more electric battery units of the subset of electric battery units to switch from the non-conducting state to the conducting state.

9. The method according to claim 1, wherein the method comprises setting the vehicle in the charging mode for less than five minutes.

10. The method according to claim 1, wherein the method is performed recurringly during a time period before the scheduled departure time.

11. The method according to claim 10, wherein when the method is performed recurringly during said time period, the method is performed such that different subsets of electric battery units are used during said time period.

12. A computer program product stored on a non-transitory computer-readable medium, said computer program product for charging a plurality of electric battery units of a vehicle, wherein said computer program product comprising computer instructions to cause one or more computer processors to perform the following operations:
wake up the vehicle to a wake-up mode;
when the vehicle is in the wake-up mode, set the vehicle in a charging mode;
when the vehicle is in the charging mode, connect one or more electric battery units of a subset of electric battery units of the plurality of electric battery units so as to charge the connected one or more electric battery units of the subset of electric battery units; and
when the vehicle is in the charging mode, check the status of the vehicle.

13. (canceled)

14. A control arrangement for charging a plurality of electric battery units of a vehicle, wherein the control arrangement is configured to:
wake up the vehicle to a wake-up mode;
when the vehicle is in the wake-up mode, set the vehicle in a charging mode;
when the vehicle is in the charging mode, connect one or more electric battery units of a subset of electric battery units of the plurality of electric battery units so as to charge the connected one or more electric battery units of the subset of electric battery units; and
when the vehicle is in the charging mode, check the status of the vehicle.

15. A vehicle comprising a control arrangement for charging a plurality of electric battery units of the vehicle, wherein the control arrangement is configured to:
wake up the vehicle to a wake-up mode;
when the vehicle is in the wake-up mode, set the vehicle in a charging mode;
when the vehicle is in the charging mode, connect one or more electric battery units of a subset of electric battery units of the plurality of electric battery units so as to charge the connected one or more electric battery units of the subset of electric battery units; and
when the vehicle is in the charging mode, check the status of the vehicle.
